(19) United States
(12) Patent Application Publication
(10) Pub. No.: US 2007/0000592 A1
(43) Pub. Date: Jan. 4, 2007

(54) Apparatus and method to operate on one or more attach sites in die package assembly

(75) Inventors: Farokh Fares, Chandler, AZ (US); Erming Luo, Chandler, AZ (US); Devendra Natekar, Chandler, AZ (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/172,029

(22) Filed: Jun. 29, 2005

(51) Int. Cl. B32B 37/12; B32B 38/00; B32B 37/06

(52) U.S. Cl. 156/64; 156/539; 156/578; 156/556; 156/566; 156/378; 156/356; 156/362; 156/297

(57) ABSTRACT

An assembly arrangement includes an assembly head having plural nozzles. The assembly head is designed to operate on a group of attach sites of a substrate at substantially the same time and is designed to be moveable relative to the substrate to allow the plural nozzles to successively operate on different groups of attach sites of the substrate.

### TECHNICAL FIELD

Embodiments of the present invention relate generally to silicon die package assembly, and more particularly to an arrangement and method wherein one or more dice attach sites can be operated on at substantially the same time.

### BACKGROUND

Silicon die packages may be attached onto a substrate by at least two ways. One way is by first dispensing an underfill material, for example an epoxy, onto an attach site with a dispense-head, for example a no-flow underfill (NUF), then picking a die from one site and placing it onto the attach site with a pick-and-place head. Another way is to place the die with a pick-and-place head at the site, and in a later operation applying an underfill near a joint between the die and the attach site and allow the underfill to wick into the joint. A capillary underfill (CUF) is an example underfill that may be used in this way. In either case, a separate bond-head may contact a top surface of one or more of the placed die, supply heat and exert pressure in a process called thermal compression bonding (TCB). Prior to the underfill dispense and die attach, the substrate is usually singulated, meaning it is separated into individual units corresponding to the individual die to be attached thereto.

The singulated substrate units may be placed into a process carrier which may hold, for example, 12 substrate units. Each substrate unit is then aligned below an underfill dispense nozzle in succession by moving the process carrier in a horizontal plane. The nozzle may then move vertically to each attach site to dispense the underfill when in position. Similarly, to place die the process carrier may move in a horizontal plane to sequentially align each substrate unit below a pick-and-place head for attachment. Underfill contemplated today may have desirable properties that degrade over time upon exposure to ambient conditions possibly affecting solder joint integrity. When a large number of attach sites sequentially receive underfill, the time duration between dispense at a first attach site and a last attach site may be unacceptable.

Efforts to shorten the duration to dispense underfill, place die, and bond die onto multiple substrate units include using respective multiple dispense stations, multiple pick-and-place stations, and multiple bonding stations on a single assembly line. A station being a discrete assembly line site wherein a particular operation takes place. If, for example, two underfill dispense stations are on a single assembly line the time to dispense underfill to any “batch” of substrates may be roughly cut in half. Similar savings may be achieved using multiple other stations.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a perspective view in accordance with a first described embodiment of the present invention;

FIG. 2 illustrates a perspective view in accordance with a second described embodiment of the present invention;

FIG. 3 illustrates a perspective view in accordance with the second described embodiment of the present invention;

FIG. 4 illustrates a front view with part illustrated in cross-section in accordance with another described embodiment of the present invention;

FIGS. 5a and 5b illustrate a front view with part illustrated in cross-section in accordance with another described embodiment of the present invention;

FIG. 6 illustrates a front view with part illustrated in cross-section in accordance with another described embodiment of the present invention;

FIG. 7 illustrates a front view with part illustrated in cross-section in accordance with another described embodiment of the present invention;

FIG. 8 illustrates a block diagram of a system in accordance with another described embodiment of the present invention;

FIG. 9 illustrates a block diagram of a system in accordance with another described embodiment of the present invention;

FIG. 10 illustrates a flow diagram of a method in accordance with another described embodiment of the present invention;

FIG. 11 illustrates a flow diagram of a method in accordance with another described embodiment of the present invention;

FIG. 12 illustrates a flow diagram of a method in accordance with another described embodiment of the present invention;

FIG. 13 illustrates a flow diagram of a method in accordance with another described embodiment of the present invention; and

FIG. 14 illustrates a flow diagram of a method in accordance with another described embodiment of the present invention.

### DETAILED DESCRIPTION OF ILLUSTRATIVE EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made in alternate embodiments. Therefore, the following detailed description is not to be taken in a limiting sense, and the scope of embodiments in accordance with the present invention is defined by the appended claims and their equivalents.

The following description may include terms such as inner, outer, under, between, upward, downward, outward, inward, top, bottom, above, below, and the like. Such terms are used for descriptive purposes only and are not to be construed as limiting in the description or in the appended claims. That is, these terms are terms that are relative only to a point of reference and are not meant to be interpreted as limitations but are, instead, included in the following description to facilitate understanding of the various aspects of the invention.

Embodiments of the present invention may be directed to an assembly arrangement, a system or a method to operate on a group of attach sites at substantially the same time. Embodiments may include plural nozzles on a single assembly head to dispense an underfill onto one or more attach sites.

Descriptions of embodiments of the invention may refer to a substrate as a strip or a panel. The strip may be described to have a primary array of attach sites which may be separated by individual “streets” which may be grouped into secondary arrays of attach sites. One or more attach sites, which are operated on by a nozzle according to embodiments of the invention, may be called a group. The distance between adjacent attach sites may be called a site pitch. A distance between nozzles on an attach head according to embodiments of the invention may be called a nozzle pitch.

Embodiments may include an assembly head movable in a horizontal plane and movable in a vertical direction. Embodiments may include a pedestal designed to receive a substrate and to provide heat to the substrate and to a joint between a die and the substrate. Embodiments may include an assembly station which may be part of an assembly line.

It may be the case that a particular attach site is not to receive a die, or any underfill. This may be because a site has been deemed defective and placing a known good die on a defective site would be wasteful. A defective site may be identified by an indicator sometimes referred to as an X-out indicator. The known bad site may be referred to as an X-out.

Embodiments of the invention may operate upon adjacent plural attach sites within the same secondary array, for example, adjacent attach sites. Other embodiments of the invention may operate on a group made up of nonadjacent attach sites. Such embodiments may act on panels of very small pitch as the nozzle pitch may be designed to be an integral multiple of a site pitch. Such groups may be said to be indexed. Other embodiments may operate upon attach sites in different secondary arrays, which may be similarly located within the different secondary arrays. For example, the bottom left site in plural secondary arrays.

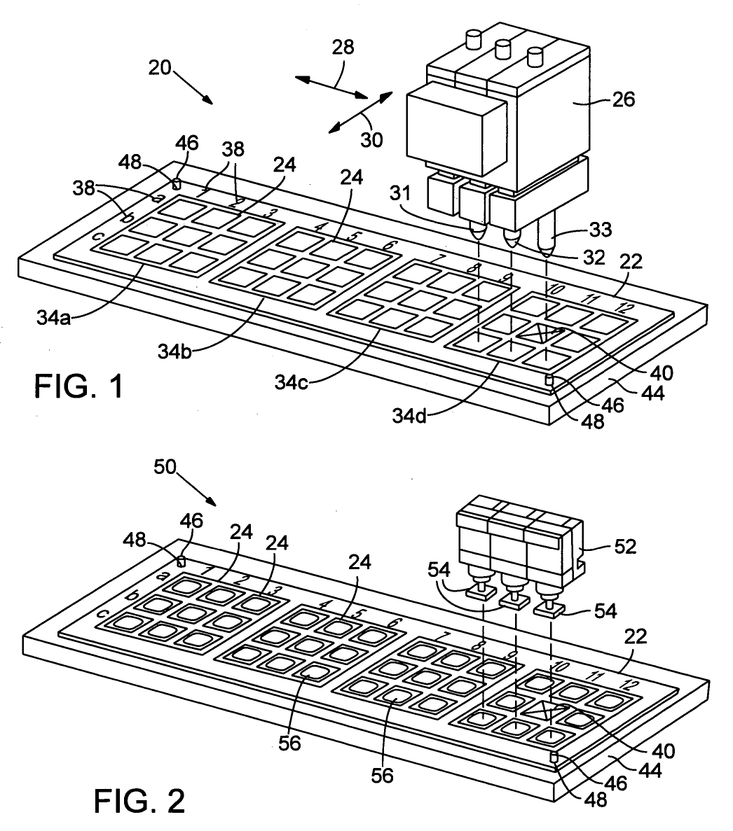

FIG. 1 is a perspective view in accordance with a first described embodiment of the invention. An assembly arrangement 20 for attaching silicon dice to a substrate 22 at multiple attach sites 24 includes an assembly head 26 designed to be movable relative the substrate 22. The assembly head 26 may be provided with at least two degrees of mobility relative to the substrate as illustrated by arrows 28 and 30. The assembly head 26 may have plural nozzles, for example, three, 31, 32, and 33 and may be designed to operate on a group of attach sites at substantially the same time, for example, the group of attach sites 24 shown below the nozzles. The assembly head 26 may be designed to apply an underfill at, for example, three attach sites at substantially the same time. The example substrate strip illustrated in FIG. 1 includes an array of 36 attach sites which may be described to include four secondary arrays of attach sites 34a, 34b, 34c, and 34d, made up of nine attach sites each. The substrate 22 illustrated includes a grid of reference designators 38 identifying columns of attach sites 1 through 12 along a horizontal axis and rows of sites a, b, and c along a vertical axis. Reference designators may or may not be inscribed on the panel. They are used here for ease of description. Any individual attach site can be identified by an intersection of a designated row with a designated column. The assembly head 26 as illustrated is positioned to dispense underfill to a first group of attach sites which can be located with reference designators 10c, 11c, and 12c. Upon dispensing underfill to the first group of attach sites the assembly head 26 may move relative to the substrate 22 to successively operate on different groups of attach sites until all the attach sites 24 which require underfill have underfill dispensed thereon.

The substrate 22 is illustrated here with an indicator 40 in the form of an “X” on one of the attach sites. Indicator 40 may be put thereon prior to this assembly operation to indicate the attach site should be skipped. The assembly head 26 may be designed to recognize the presence of one or more indicators 40 at one or more of the attach sites 24 and skip operating on any attach site 24 having an indicator 40. Example devices to recognize an indicator may be, or may include, a camera, or other optical device including an infrared detector, or an electromagnetic device, or a mechanical device, or the like. The device to recognize an indicator may be positioned on a lower side of the dispense head (not illustrated here).

In this illustrated embodiment, the substrate 22 may be supported by, or be positioned on, a pedestal 44. The pedestal 44 may include locators for properly positioning the substrate 22. For example, the pedestal 44 may include pins 46 protruding upward therefrom. The substrate 22 may include holes 48 designed to receive the pins 46. Other positioning arrangements may be used.

FIG. 2 is a perspective view illustrating another described embodiment of the invention. An assembly arrangement 50 may include an assembly head which may be a pick-and-place head 52 including a bond head designed to pick and place one or more dice 54, for example, silicon dice, for example, flip chip silicon dice to be attached at multiple attach sites 24 on substrate 22. The substrate 22 is shown with an underfill material 56 dispensed on all the attach sites except for the attach site 11b, which has been identified with an indicator 40 and has been skipped. The dice 54 may be picked from an appropriate site, for example, tape and reel packaging or tray packaging. The die may be placed in attach groups of, for example, three as shown in this illustrative embodiment.

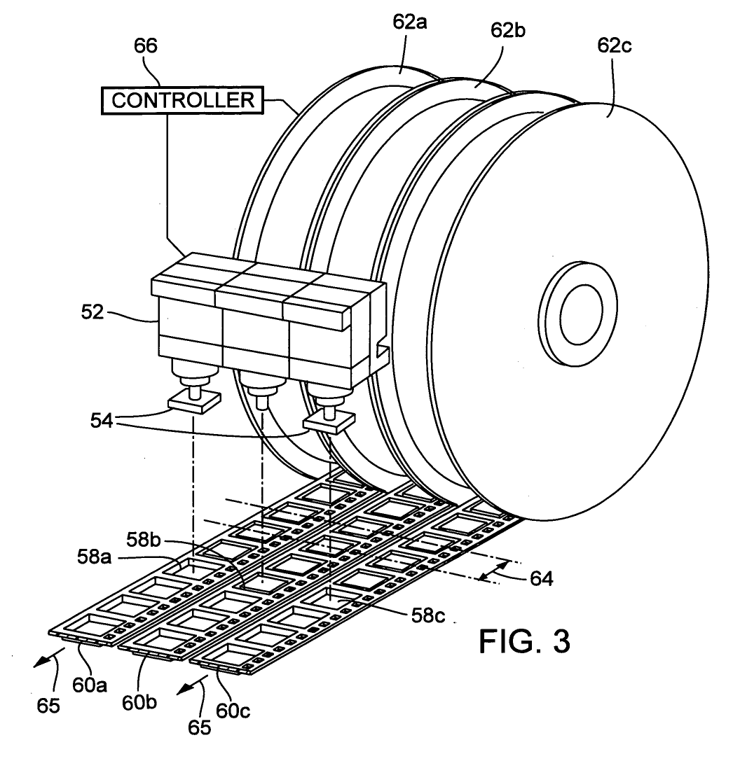

FIG. 3 illustrates an embodiment wherein as many as three dice 54 may be picked from pockets 58a, 58b, and 58c, defined in tapes 60a, 60b, and 60c on reels 62a, 62b, and 62c. In this example embodiment three reels are arranged adjacent one another and are designed to increment or advance one pocket pitch 64 each time a die is picked from a pocket. This example illustrates die having been picked from pockets 58a, and 58c in tapes 60a, and 60c, but not picked from pocket 58b illustrating an example of a group of three attach sites having an indicator in the middle thereof. FIG. 2 illustrates just such a case wherein pick-and-place head 52 may skip operating on attach site 11b, which has an indictor 40. After dice 54 are picked from pockets 58a and 58c tapes 60a and 60c may increment by a pocket pitch 64, as shown by arrows 65, and tape 60b may not increment. Any combination of die picked or skipped is possible according to this and other embodiments of the invention. A controller 66 illustrates schematically a coupling between the pick-and-place head 52 and the tapes 62a, 62b, and 62c. The controller 66 may be designed to control which nozzles to pick a die from the packaging tapes and which of the packaging tapes to advance. Other embodiments may pick die from other forms of packaging.

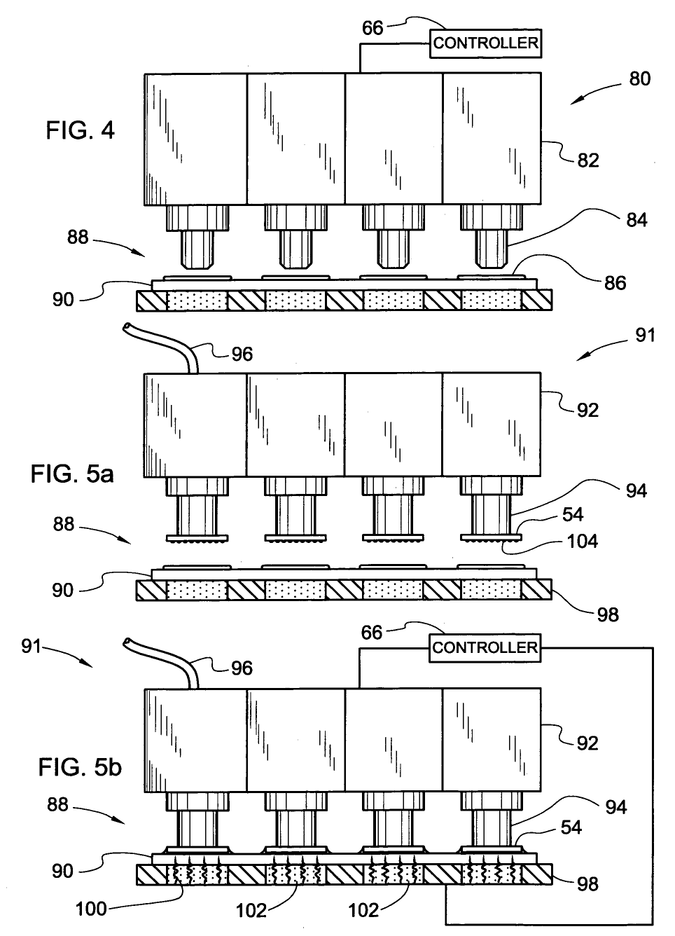

FIG. 4 illustrates a front view with part illustrated in section in accordance with an embodiment of the invention wherein an assembly arrangement 80 includes an assembly head 82 having four nozzles 84 designed to apply an underfill 86 to a group of attach sites 88 on a substrate 90. A controller 66 is shown schematically and may control which of the nozzles 84 to provide underfill.

FIGS. 5a and 5b illustrate front views with parts illustrated in section in accordance with another described embodiment of the invention. An assembly arrangement 91 includes an assembly head 92 that may be a pick-and-place and/or a bondhead having four nozzles 94 designed to pick up one or more dice 54 and place them on a group of attach sites 88. The nozzles 94 may include a vacuum connection 96 to pick and place one or more dice 54 to one or more of the attach sites by holding the one or more dice with a suction force, while lifting and moving the one or more dice 54 to one or more of a group of attach sites 88.

A pedestal 98 may be designed to receive the substrate 90, and may be designed to provide heat, illustrated with wavy arrows 100, to one or more of the group of attach sites of the substrate 90. The assembly head 92 may be designed to provide pressure to the one or more dice upon having placed the one or more dice at one or more of the group of attach sites 88 while the pedestal 98 provides heat to the group of attach sites 88. The pedestal 98 may provide heat to the bottom of the substrate 90. The pedestal 90 may include segmented heaters 102 designed to provide localized heat to the corresponding areas of the groups of attach sites 88 on the bottom of the substrate 90. A controller 66 is shown schematically and illustrates a coupling between the assembly head 92 and the pedestal 98 which may control which of the segmented heaters 102 to provide heat. Upon placing the die 54 on each of the respective attach sites 88 the nozzles 94 may exert a force downward providing pressure while the segmented heaters 102 provide heat causing, for example, solder balls 104 on the bottom of each of the die 54 to bond to the substrate.

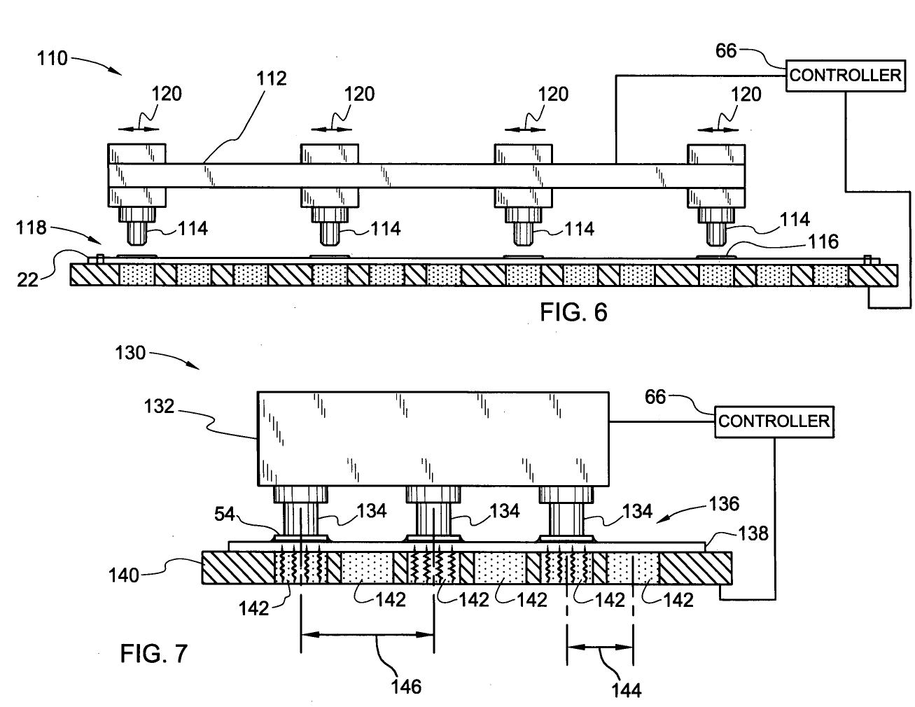

FIG. 6 illustrates a front view with part illustrated in section in accordance with another embodiment of the invention wherein an assembly arrangement 110 includes an assembly head 112 having four nozzles 114 designed to apply an underfill 116 to a group of attach sites 118 onto a substrate 22 similar to the substrate shown in FIGS. 1 and 2. In this embodiment, adjacent nozzles 114 on the assembly head are designed to operate on nonadjacent of attach sites. The nozzles 114 may operate on attach sites in different secondary arrays 34a, 34b, 34c, and 34d (FIG. 1), which may be similarly located within different secondary arrays. For example, referring to the reference designators indicated on the panel shown in FIG. 1 the four nozzles 114 may operate on respective attached sites 1c, 4c, 7c, and 10c, at substantially the same time. A controller 66 is shown schematically and may control which of the nozzles 114 to provide underfill. The assembly head 112 may be designed such that the relative spacing between the nozzles 114 may be adjustable as illustrated by arrows 120.

Another embodiment may comprise an assembly head designed to pick, place, and bond die to a group of attach site comprising nonadjacent attach sites that may, for example, be in different secondary arrays.

FIG. 7 illustrates a front view with part illustrated in section in accordance with another described embodiment of the invention. An assembly arrangement 130 includes an assembly head 132 that may be a pick-and-place and/or a bondhead having three nozzles 134 designed to pick up one or more dice 54 and place them on a group of attach sites 136. The group comprises nonadjacent attach sites. In this example embodiment a substrate 138 may include at least one row of, for example, six attach sites positioned on a pedestal 140 which may include six segmented heaters 142, each spaced a site pitch 144 apart. The site pitch may be, for example, 16 mm, and may be, for example, 13 mm or smaller. The location of each segmented heater corresponds to the location of each attach site. The nozzles 134 on the assembly head 132 are spaced a nozzle pitch 146 apart. The nozzle pitch 146 is substantially equal to an integral multiple of the site pitch 144. In this example, the assembly head 132 may operate on alternate attach sites, and alternate segmented heaters 142 may correspondingly provide heat. The operation may be controlled by a controller 66.

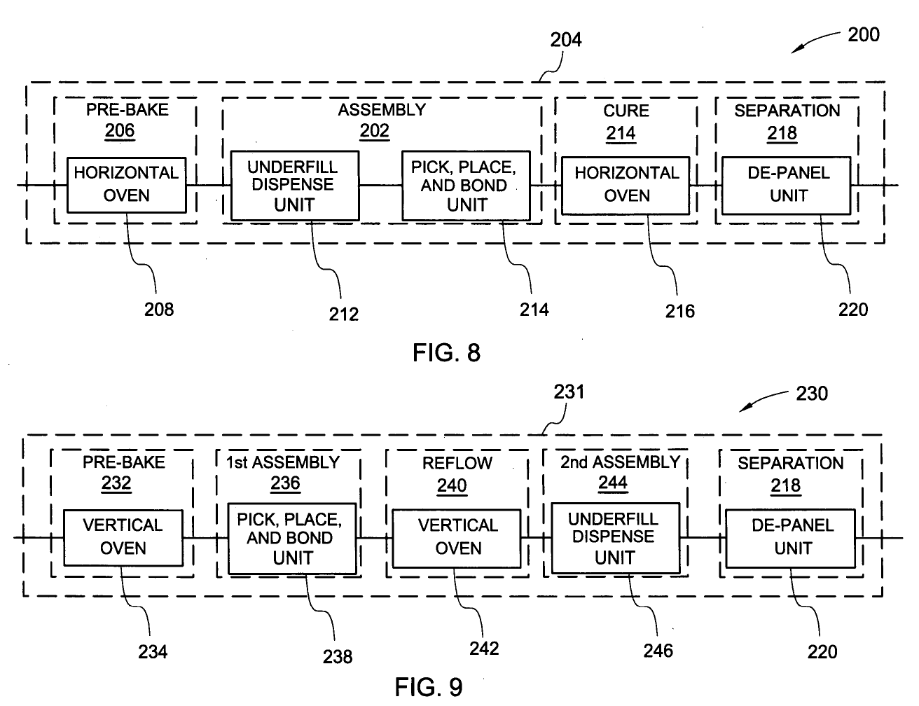

FIG. 8 illustrates a block diagram of a system 200, according to another embodiment of the invention, which is just one of many possible systems in which one or more of the earlier described assembly arrangements may be used. The system 200, may include one or more assembly arrangements herein. In this illustrated system 200, an assembly station 202 may be on an assembly line 204 (all or a portion of which is illustrated here). The assembly station 202 may include an assembly head which may have plural nozzles designed to operate on a group of attach sites of a substrate at substantially the same time, and may be designed to be moveable relative to the substrate to allow the plural nozzles to successively operate on different groups of attach sites of the substrate. The system 200 may also include a pre-bake station 206 which in this example embodiment may include a horizontal oven 208. The horizontal oven 208 may be used to remove moisture from the substrate panels. The substrate panels may then be moved to an assembly station 202 comprising an assembly arrangement as described herein. The assembly station 202 may include an underfill dispense unit 212 and a pick, place, and bond unit 214. After passing through the assembly station 202 the substrate panel may undergo a cure operation at a cure station 214 which may include heating the panel. The cure station 214 may also include a horizontal oven 216. A separation station 218 may also be included in the system 200 and may include a de-panel unit 220 to separate the substrate panel into separate units, each including one or more dice attached thereto.

Another embodiment may include a ball attach station wherein multiple solder balls are attached to each substrate unit to enable the substrate unit to in turn be attached to, for example, a printed-circuit board. Another embodiment may include additional stations on the assembly line, for example, equipment to attach an integrated heat spreader (IHS) at, for example, an IHS attach station (not shown). Another embodiment may include a molding station (not shown) to encapsulate the multiple dice by, for example, injection molding. The molding operation may take place before the separation station. Such an arrangement may be useful for producing molded matrix array packages (MMAP). Other embodiments, not illustrated here, may use a vertical oven as part of the pre-bake station and a vertical oven as part of the cure station. They also may be mixed and matched in any combination. Solder flux may be used to facilitate soldering, and a flux clean station may be positioned to follow a cure or reflow station to clean flux from around the balls.

FIG. 9 illustrates a block diagram of a system 230, according to another embodiment of the invention. The system 230 may include more that one assembly station, as described herein, on an assembly line 231. A pre-bake station 232, which may include a vertical oven 234, may prepare a substrate for a 1^{st} assembly station 236 wherein one or more dice may be placed on the substrate which may include a pick, place, and bond unit 238 as described in one or more of the earlier described embodiments. Other embodiments may include a horizontal oven. Then solder joints may be cured in a reflow station 240 which may include a vertical oven 242 as illustrated in this embodiment. Other embodiments may include a horizontal oven. Then a 2^{nd} assembly station 244 may include an underfill dispense unit 246 to dispense underfill onto one or more attach sites as described in one or more of the earlier described embodiments. For example, a capillary underfill (CUF) may be dispensed at multiple attach sites, and which may flow under each of the die at the multiple attach sites which may fill most or all of the gaps between the die and substrate among the solder joints. A separation station 218 similar to the embodiment shown in FIG. 8 may also be included in the system 230 and may include a de-panel unit 220 to separate the substrate panel into separate units that each includes one or more dice attached thereto.

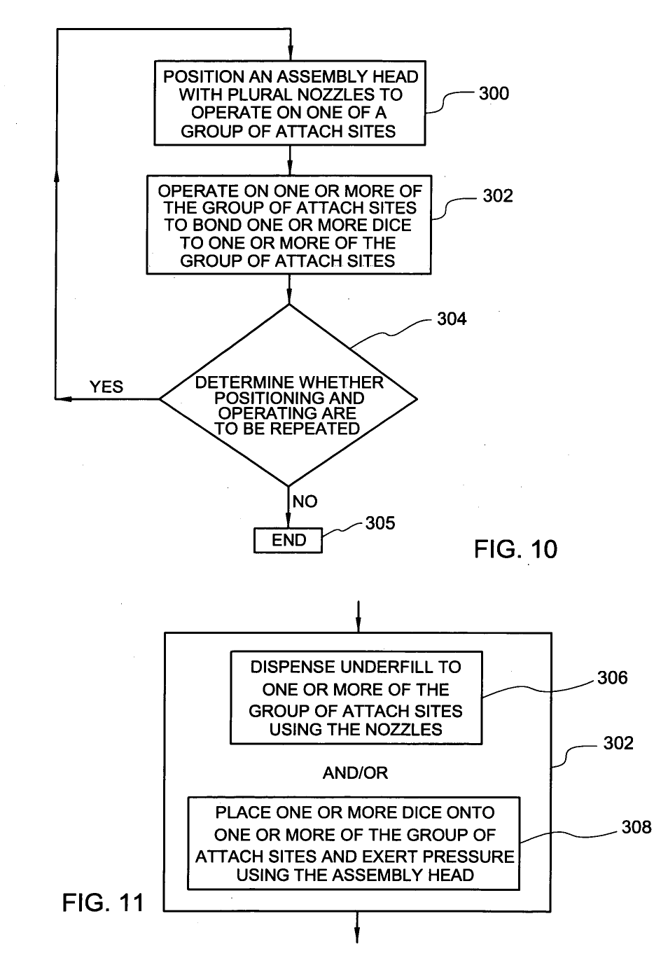

FIG. 10 is a flow diagram illustrating a method in accordance with an embodiment of the invention. The method includes:

positioning an assembly head with a plurality of nozzles to operate on one or more of a group of attach sites of a substrate, 300;

operating on one or more of the group of attach sites to bond one or more dice to one or more of the group of attach sites, using the assembly head, 302; and

a determination is made on whether the positioning and operating operations are to be repeated, 304. Typically, if there is at least one other group of attach sites of the substrate is to be operated on, the positioning and operating operations are repeated. On the other hand, if all groups of attach sites have been operated on, the process terminates, 305.

FIG. 11 is a flow diagram illustrating another method in accordance with another embodiment of the invention. In this embodiment, operating 302 may comprise one or both of:

dispensing underfill to one or more of the group of attach sites being operated on, using the nozzles, 306; and/or

placing one or more dice onto one or more of the group of attach sites and exerting pressure on the one or more dice, using the assembly head, 308.

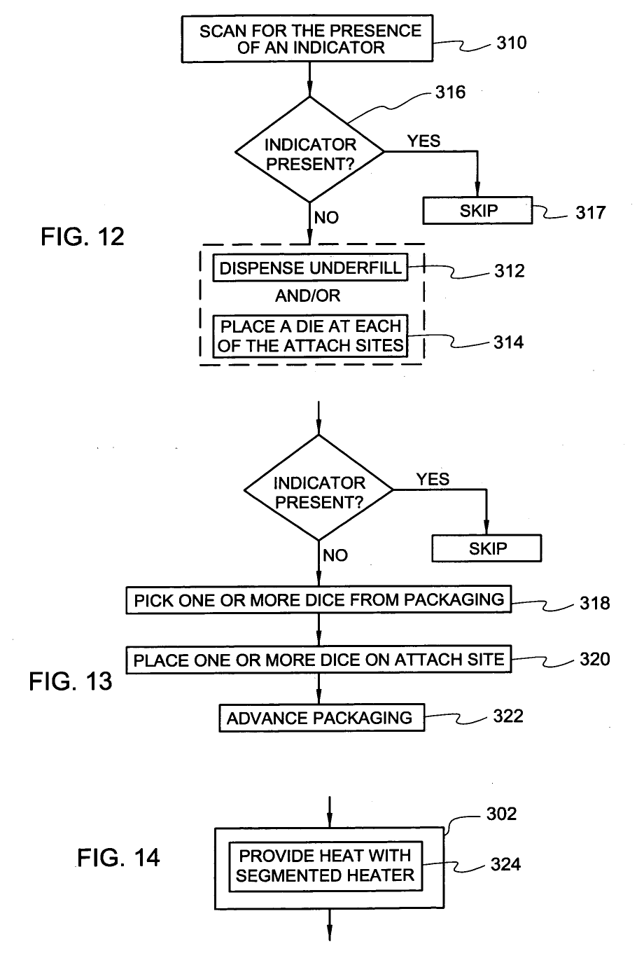

FIG. 12 is a flow diagram illustrating another method in accordance with another embodiment of the invention. In this embodiment a method may further comprise scanning the group of attach sites for the presence of indicators, 310, and determining whether or not to do one, or both, of: dispensing underfill, 312, and placing a die, 314, at each of the attach sites based at least in part on the presence or absence of the indicators as illustrated by the decision box, 316. If an indicator at a particular attach site is present, the method includes skipping the attach site, 317.

FIG. 13 is a flow diagram illustrating another method in accordance with another embodiment of the invention. In this embodiment, a method includes picking one or more dice from one or more pockets in one or more packaging tapes with nozzles, for attach sites that do not have the indicators 318, placing the one or more dice onto the attach sites of the substrate, 320, and advancing the packaging tapes from which dice were picked, 322.

FIG. 14 is a flow diagram illustrating another method in accordance with another embodiment of the invention. In this embodiment, operating 302 may further comprise providing heat to areas corresponding to the one or more of the group of attach sites, e.g., on corresponding areas of the attach sites on an opposite surface of the substrate, with one or more segmented heaters. In various embodiments, the heaters may be disposed on a pedestal holding the substrate 324.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An assembly arrangement comprising:
an assembly head;
plural nozzles on said assembly head designed to operate on a group of attach sites of a substrate at substantially the same time; and
the assembly head is designed to be moveable relative to the substrate to allow the plural nozzles to successively operate on different groups of attach sites of the substrate.

2. The assembly arrangement of claim 1 wherein said nozzles are designed to apply underfill to said attach sites.

3. The assembly arrangement of claim 1, wherein the assembly head is provided with at least two degrees of mobility relative to the substrate.

4. The assembly arrangement of claim 1 wherein adjacent nozzles are designed to operate on nonadjacent attach sites.

5. The assembly arrangement of claim 1 wherein said assembly head further comprises a bondhead designed to pick up one or more dice from a pick location and place the one or more dice at one or more of the groups of attach sites; and
said bondhead is designed to exert pressure on the one or more dice to help bond the one or more dice to the one or more of the groups of attach sites.

6. The assembly arrangement of claim 5 further comprising a pedestal designed to receive the substrate and designed to provide heat to the one or more groups of attach sites of the substrate while said bondhead provides pressure to the one or more dice being bonded to one or more of the one or more groups of attach sites being provided with heat.

7. The assembly arrangement of claim 1 wherein said plural nozzles include a vacuum connection to pick and place the one or more dice to one or more of the attach sites by holding the one or more dice with a suction force, while lifting and moving the one or more dice to one or more of a group of attach sites.

8. The assembly arrangement of claim 1 further comprising a pedestal designed to provide heat to one or more groups of attach sites of the substrate; and
said assembly head is a pick-and-place head designed to pick and place one or more dice onto one or more of a group of attach sites, and provide pressure to the one or more dice upon having-placed the one or more dice at one or more of the group of attach sites while said pedestal provides heat to the group of attach sites.

9. The assembly arrangement of claim 8 wherein the groups of attach sites are located on a top surface of the substrate, and said pedestal is designed to provide heat to corresponding areas of the groups of attach sites on a bottom surface of the substrate.

10. The assembly arrangement of claim 9 wherein said pedestal includes segmented heaters designed to provide localized heat to the corresponding areas of the groups of attach sites on the bottom surface of the substrate.

11. The assembly arrangement of claim 1 wherein said assembly head is designed to recognize presence of one or more indicators at one or more of the attach sites, and controllable to skip operating on any of the attach sites having the indicator.

12. A system comprising:
an assembly station on an assembly line including an assembly head, said assembly head having plural nozzles designed to operate on a group of attach sites of a substrate at substantially the same time, and designed to be moveable relative to the substrate to allow the plural nozzles to successively operate on different groups of attach sites of the substrate; and
a horizontal oven being arranged on said assembly line and being designed to cure interconnections between dice and the attach sites.

13. The system of claim 12 wherein said nozzles are designed to apply an underfill to the attach sites.

14. The system of claim 12 wherein the assembly head is provided with at least two degrees of mobility relative to the substrate.

15. The system of claim 12 wherein said assembly head further comprises a bondhead designed to pick up one or more dice from a pick location and place the one or more dice at one or more of the groups of attach sites, with said bondhead designed to exert pressure on the one or more dice to help bond the one or more dice to the one or more of the groups of attach sites.

16. The system of claim 15 further comprising a pedestal designed to receive the substrate and designed to provide heat to the one or more groups of attach sites of the substrate while said bondhead provides pressure to the one or more dice being bonded to one or more of the one or more groups of attach sites being provided with heat.

17. The system of claim 12 wherein said plural nozzles include a vacuum connection to pick and place the one or more dice to one or more of the attach sites by holding the one or more dice with a suction force, while lifting and moving the one or more dice to one or more of a group of attach sites.

18. The system of claim 12 further comprising a pedestal designed to provide heat to one or more groups of attach sites of the substrate; and
said assembly head is a pick-and-place head designed to pick and place one or more dice onto one or more of a group of attach sites, and provide pressure to the one or more dice upon having placed the one or more dice at one or more of the group of attach sites while said pedestal provides heat to the group of attach sites.

19. The system of claim 18 wherein said pedestal includes segmented heaters designed to provide localized heat to the corresponding areas of the groups of attach sites on the bottom surface of the substrate.

20. The system of claim 18 further comprising a controller; and
said assembly head is coupled to said controller and designed to receive a signal based on the presence or absence of an indicator at one or more attach sites, and said controller designed to operate on one or more attach sites based on the signal and to control one or more of:
which of the nozzles to dispense underfill;
which of the segmented heaters to provide heat;
which of the nozzles to pick a die from plural packaging tapes; and
which of the packaging tapes to advance.

21. A method comprising:
positioning an assembly head with a plurality of nozzles to operate on one or more of a group of attach sites of a substrate;
operating on one or more of the group of attach sites to bond one or more dice to one or more of the group of attach sites, using the assembly head; and
repeating said positioning and operating for at least one other group of attach sites of the substrate.

22. The method of claim 21 wherein the operating comprises one or both of:
dispensing underfill to one or more of the group of attach sites being operated on, using the nozzles; and
placing one or more dice onto one or more of the group of attach sites and exerting pressure on the one or more dice, using the assembly head.

23. The method of claim 22 further comprising scanning the group of attach sites for presence of indicators, and determining whether or not to do one of: dispensing underfill, and placing a die, at each of the attach sites based at least in part on the presence or absence of the indicators.

24. The method of claim 23 wherein:
the operating comprises picking one or more dice from one or more pockets in one or more packaging tapes with nozzles corresponding to the attach sites that do not have the indicators, and advancing the packaging tapes from which dice were picked.

25. The method of claim 21 wherein the operating further comprises providing heat to areas corresponding to the one or more of the group of attach sites on an opposite surface of the substrate with segmented heater of a pedestal holding the substrate.
